(19) United States
(12) Patent Application Publication
(10) Pub. No.: US 2006/0265517 A1
(43) Pub. Date: Nov. 23, 2006

(54) TCP/IP RECEPTION PROCESS CIRCUIT AND SEMICONDUCTOR INTEGRATED CIRTUIT HAVING THE SAME

(75) Inventors: Koji HASHIMOTO, Suwa (JP); Chisato HIGUCHI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/419,042

(22) Filed: May 18, 2006

(30) Foreign Application Priority Data
May 20, 2005 (JP) 2005-147618

(51) Int. Cl. G06F 15/16

(52) U.S. Cl. 709/245

(57) ABSTRACT

A transmission control protocol/Internet protocol (TCP/IP) reception processing circuit that transmits a packet included in a frame and received from a lower layer to memory accessible by an upper layer, in that: the memory includes: a communication endpoint information area which contains a plurality of packet storage areas, with each packet storage area storing a plurality of packets addressed to a predetermined communication endpoint, and which contains a plurality of descriptor tables linked to a first pointer included in each packet storage area, with each descriptor table having a second pointer that points out the packet storage area and having packet writable/non-writable information that indicates whether or not the packet can be written into the packet storage area pointed out by the second pointer; and, if a packet included in a frame and received from the lower layer is a packet addressed to the predetermined communication endpoint, one out of the plurality of descriptor tables that points out the packet storage area into which the packet can be written is determined by using the first pointer and the packet writable/non-writable information, and the packet included in the frame and received from the lower layer is transferred into the packet storage area pointed out by the second pointer in this descriptor table.

### BACKGROUND

1. Technical Field

The present invention relates to a transmission control protocol/Internet protocol (TCP/IP) reception processing circuit that conducts reception processing of the TCP/IP. Further, the invention relates to a semiconductor integrated circuit having such a TCP/IP reception processing circuit.

2. Related Art

A hierarchical model of a communication protocol called TCP/IP is widely used today in networks such as the Internet and local area networks (LANs). FIG. 8 is a diagram showing a rough corresponding relationship between layers of a TCP/IP hierarchical model and layers of an open system interconnection (OSI) reference model established by the International Organization for Standardization (ISO).

As a network interface layer of the TCP/IP hierarchical model, Ethernet (trademark) is widely used; as an Internet layer of the TCP/IP hierarchical model, Internet protocol (IP) version 4 (hereinafter referred to simply as “IP”) is widely used; and as a transport layer of the TCP/IP hierarchical model, a transmission control protocol (TCP) or a user datagram protocol (UDP) is widely used. Ethernet (trademark) is defined, in e.g., IEEE802.3; IP is defined in, e.g., Request for Comments (RFC) 791; TCP is defined in, e.g., RFC793; and UDP is defined in, e.g., RFC768.

Further, protocols for network management, an address resolution protocol (ARP) and a reverse address resolution protocol (RARP) equivalent to the Internet layer of the TCP/IP hierarchical model are widely used, and an Internet control message protocol (ICMP) equivalent to the transport layer of the TCP/IP hierarchical model is widely used. The ARP is defined in, e.g., RFC826; the RARP is defined in, e.g., RFC903; and the ICMP is defined in, e.g., RFC792.

FIG. 9 is a diagram showing a format of an Ethernet (trademark) frame (hereinafter referred to simply as a “frame”). As shown in FIG. 9, the frame includes a header and a payload. When the frame is transmitted through network, a preamble is appended to the head, and a frame check sequence storing a cyclic redundancy check (CRC) is appended to the end.

FIG. 10 is a diagram showing a format of an IP packet. As shown in FIG. 10, the IP packet includes an IP header and an IP payload. The TP packet is stored in the payload (see FIG. 9) of the frame.

FIG. 11 is a diagram showing a format of an ARP/RARP packet. The ARP/RARP packet is stored in the payload (see FIG. 9) of the frame.

FIG. 12 is a diagram showing a format of a TCP packet. As shown in FIG. 12, the TCP packet includes a TCP header and a TCP payload. The TCP packet is stored in the payload (see FIG. 9) of the IP packet.

FIG. 13 is a diagram showing a format of a UDP packet. As shown in FIG. 13, the UDP packet includes a UDP header and a UDP payload. The UDP packet is stored in the payload (see FIG. 10) of the IP packet.

FIG. 14 is a diagram showing a format of an ICMP packet. The ICMP packet is stored in the payload (see FIG. 10) of the IP packet.

in the conventional TCP/IP reception processing, the network interface layer is often implemented by a hardware circuit (hereinafter referred to as a network interface card: NIC), and the layers of from Internet to application are often implemented by a CPU and software (a program). However, when the layers of from Internet to application are implemented by the CPU and the software (the program), there is a problem that the CPU carries a heavy burden in implementing the application layer. Thus, in recent years, it has been tried to lift the burden on the CPU by implementing the Internet layer and/or part of the transport layer using the hardware circuit.

One related technique is JP-A-11-168451 (p. 1, FIG. 1), which discloses a method of receiving data at a network node that includes a network adapter and a protocol stack having a plurality of layers, the method comprising: transferring packet bytes that form an incoming data packet from network media to memory; calculating a code from packet bytes that form a portion of the incoming data packet as the packet bytes are transferred from network media to memory; transferring the code to a code channel associated with the protocol stack; receiving data extracted from the data packet at a first layer of the plurality of layers of the protocol stack; and verifying the extracted data using the code from the code channel.

This method enables calculation of checksums or the like of the TCP when packets are transferred from network media to memory.

Further, JP-A-6-78001 (p. 1, FIG. 1) discloses: in a computing system connected to a network, the computing system including a main memory and a network adapter, a method for forwarding to the main memory a network packet received by the network adapter from the network, the method comprising the steps of: (a) placing, by the network adapter, a header for the network packet into a first memory buffer in the main memory; and (b) placing, by the network adapter, data contained by the network packet beginning at a second memory buffer in the main memory.

With this method, the data and the header of an incoming packet can be splitted and stored in separate memory buffers.

Generally, an application program (e.g., a web browser program or a mail client program) executed at the application layer receives a packet from a communication endpoint that is provided by an application programming interface (API) on an operating system (OS). The packet is supplied to this communication endpoint by the OS. Upon receipt of the packet via a device driver (a program) from the NIC, the OS determines whether or not the packet is a packet addressed to an existing communication endpoint and, if it is, supplies the packet to the relevant communication endpoint.

An API specification of an communication endpoint of the TCP/IP of ITRON is provided by a non-patent document: Embedded TCP/IP Technical Committee, ITRON Technical Committee of TRON Association; In Hiroaki Takada (Ed.), “ITRON TCP/IP API Specification Ver. 1.00,01,” May 19, 1998, [Online] Retrieved on Apr. 13, 2005 from http://www.assoc.tron.org/spec/itron/tcpic-100j.pdf.

In general, the basic process unit in the layers of from network interface to transport is a packet. The API of the communication endpoint, also, is often coded to send the packets one by one to the application layer. In this case, the application layer receives the packets one by one from the communication endpoint.

However, the basic process unit in the application program is often a logical data stream containing a plurality of packets. In the application layer, because it is necessary to produce the logic data stream out of a plurality of packets, the production load in the system as a whole becomes heavy.

The NIC performs separation of a header section of the TCP or the UDP and a data section of the TCP or the UDP, checksum verification, and so forth. However, the analysis information obtained from the separation of the header section and the data section, the checksum verification, and the like by the NIC is not used properly by the OS when determining whether or not the packet is the existing packet addressed to the communication endpoint.

Further, in a route from the NIC to the OS or from the API to the application program (between the network interface layer and the application layer), memory copying of the frame or the packet occurs.

### SUMMARY

An advantage of the invention is to provide a TCP/IP reception processing circuit with which the load in producing a logical data stream out of a plurality of packets is reduced. Further, the invention provides a semiconductor integrated circuit having such a TCP/IP reception processing circuit.

One aspect of the invention is a transmission control protocol/Internet protocol (TCP/IP) reception processing circuit that transmits a packet included in a frame and received from a lower layer to memory accessible by an upper layer, in that: the memory includes: a communication endpoint information area which contains a plurality of packet storage areas, with each packet storage area storing a plurality of packets addressed to a predetermined communication endpoint, and which contains a plurality of descriptor tables linked to a first pointer included in each packet storage area, with each descriptor table having a second pointer that points out the packet storage area and having packet writable/non-writable information that indicates whether or not the packet can be written into the packet storage area pointed out by the second pointer; and, if a packet included in a frame and received from the lower layer is a packet addressed to the predetermined communication endpoint, one out of the plurality of descriptor tables that points out a packet storage area into which the packet can be written is determined by using the first pointer and the packet writable/non-writable information, and the packet included in the frame and received from the lower layer is transferred into the packet storage area pointed out by the second pointer in this descriptor table.

With the TCP/IP reception processing circuit: each of the plurality of packet storage areas may include a header storage area that stores a header of a packet and a payload storage area that stores a payload of a packet; the second pointer may include a third pointer that points out the header storage area and a fourth pointer that points out the payload storage area; and, if a packet included in a frame and received from the lower layer is a packet addressed to the predetermined communication endpoint, one out of the plurality of descriptor tables that points out the packet storage area into which the packet can be written may be determined by using the first pointer and the packet writable/non-writable information; a header of the packet included in the frame and received from the lower layer may be transferred into the header storage area that is pointed out by the third pointer in this descriptor table; and a payload of the packet included in the frame and received from the lower layer may be transferred into the packet storage area that is pointed out by the fourth pointer in this descriptor table.

Further, the payload storage areas in the plurality of packet storage areas may be arranged at successive addresses in the memory.

Further, each of the plurality of descriptor tables may further include header storage area size information indicating a size of a header storable in the header storage area and payload storage area size information indicating a size of a payload storable in the payload storage area; and, if a packet included in a frame and received from the lower layer is a packet addressed to the predetermined communication endpoint, one out of the plurality of descriptor tables that points out the packet storage area into which the packet can be written may be determined by using the first pointer and the packet writable/non-writable information; and, when a size of a header of a packet included in a frame and received from the lower layer is larger than a size indicated by the header storage area size information in this descriptor table, part of the header of the packet included in the frame and received from the lower layer that is storable in the header storage area in this descriptor table may be transferred to the header storage area of this descriptor table; and, when a size of a payload of a packet included in a frame and received from the lower layer is larger than a size indicated by the payload storage area size information in this descriptor table, part of the payload of the packet included in the frame and received from the lower layer that is storable in the payload storage area in this descriptor table may be transferred to the payload storage area of this descriptor table.

Also, the TCP/IP reception processing circuit may include: a decrement counter with which an initial size of a logical data stream block of the predetermined communication endpoint can be set by the upper layer, in that: if a packet included in a frame and received from the lower layer is a packet addressed to the predetermined communication endpoint, the decrement counter may subtract a value equivalent to a size of a payload of the packet included in the frame and received from the lower layer; and, when the value of the decrement counter becomes 0, a control signal to the upper layer may be output announcing that the value has become 0.

Further, if the predetermined communication endpoint is a communication endpoint of a transmission control protocol (TCP), the memory may further include an RST packet storage area that stores an RST packet addressed to the predetermined communication endpoint and an RST descriptor table having a pointer that points out the RST packet storage area; and if a packet included in a frame and received from the lower layer is an RST packet addressed to the predetermined communication endpoint, the RST packet may be transferred into the RST packet storage area pointed out by the pointer in the RST descriptor table.

Furthermore, the TCP/IP reception processing circuit may further include: an addition counter with which an initial value of a sequence number of the predetermined communication endpoint can be set by the upper layer, in that: if a packet included in a frame and received from the lower layer is a packet addressed to the predetermined communication endpoint, and if a sequence number in a TCP header of this packet is equivalent to a value of the addition counter, the packet included in the frame and received from the lower layer may be transferred to the memory while the value of the addition counter is incremented.

Moreover, each of the plurality of descriptor tables may further include an analysis result storage area that stores an analysis result of a frame received from the lower layer or an analysis result of a packet included in a frame and received from the lower layer; and, if a packet included in a frame and received from the lower layer is a packet addressed to the predetermined communication endpoint, one out of the plurality of descriptor tables that points out the packet storage area into which the packet can be written may be determined by using the first pointer and the packet writable/non-writable information, and the packet included in the frame and received from the lower layer may be transferred into the packet storage area pointed out by the second pointer in this descriptor table, while an analysis result of the frame received from the lower layer or an analysis result of the packet included in the frame and received from the lower layer may be written into the analysis result storage area in this descriptor table

Further, the memory may include the plurality of communication endpoint information areas each corresponding to a plurality of communication endpoints; and, if a packet included in a frame and received from the lower layer is a packet addressed to any of the plurality of communication endpoints, this packet may be written into a packet storage area indicated in a descriptor table in a communication endpoint information area, out of the plurality of communication endpoint information areas, that corresponds to the communication endpoint that is the destination of this packet.

Furthermore, if a protocol of a packet included in a frame and received from the lower layer is not a prescribed protocol or if a packet included in a frame and received from the lower layer is a packet not addressed to any of the plurality of communication endpoints, the memory may further include a second communication endpoint information area that stores this frame or this packet; and, if the protocol of a packet included in a frame and received from the lower layer is not a prescribed protocol or if a packet included in a frame and received from the lower layer is a packet not addressed to any of the plurality of communication endpoints, and if a protocol of a packet included in a frame and received from the lower layer is not a prescribed protocol or if a packet included in a frame and received from the lower layer is a packet not addressed to any of the plurality of communication endpoints, this frame or this packet may be transferred to a packet storage area indicated in a descriptor table in the second communication endpoint information area.

Another aspect of the invention is a semiconductor integrated circuit having the TCP/IP reception processing circuit of the one aspect of the invention.

### BRIEF DESCRIPTION OF THE DRAWINGS

The invention will be described with reference to the accompanying drawings, wherein like numbers reference like elements.

FIG. 1 is a diagram of a system using a TCP/IP reception processing circuit of one embodiment of the invention.

FIG. 2 is a diagram showing the contents of a main memory 9 and registers in a DMA control section 24 of FIG. 1.

FIG. 3 is a diagram showing a format of a descriptor table of FIG. 2.

FIG. 4 is a diagram showing a format of a communication endpoint condition-setting table of FIG. 2.

FIGS. 5A and 5B are diagrams showing the contents of the main memory 9 of FIG. 1.

FIG. 6 is a flowchart showing the operation of a TCP/IP reception processing circuit 5 of FIG. 1.

FIG. 7 is a flowchart showing the operation of the TCP/IP reception processing circuit 5 of FIG. 1.

FIG. 8 is a diagram showing a corresponding relation between an OSI reference model and a TCI/IP hierarchical model.

FIG. 9 is a diagram showing a format of a frame.

FIG. 10 is a diagram showing a format of an IP packet.

FIG. 11 is a diagram showing a format of an ARP/RARP packet.

FIG. 12 is a diagram showing a format of a TCP packet.

FIG. 13 is a diagram showing a format of a UDP packet.

FIG. 14 is a diagram showing a format of an ICMP packet.

### DESCRIPTION OF EXEMPLARY EMBODIMENTS

Embodiment of the invention will now be described with reference to the drawings, in which the same reference numbers are given to the same elements.

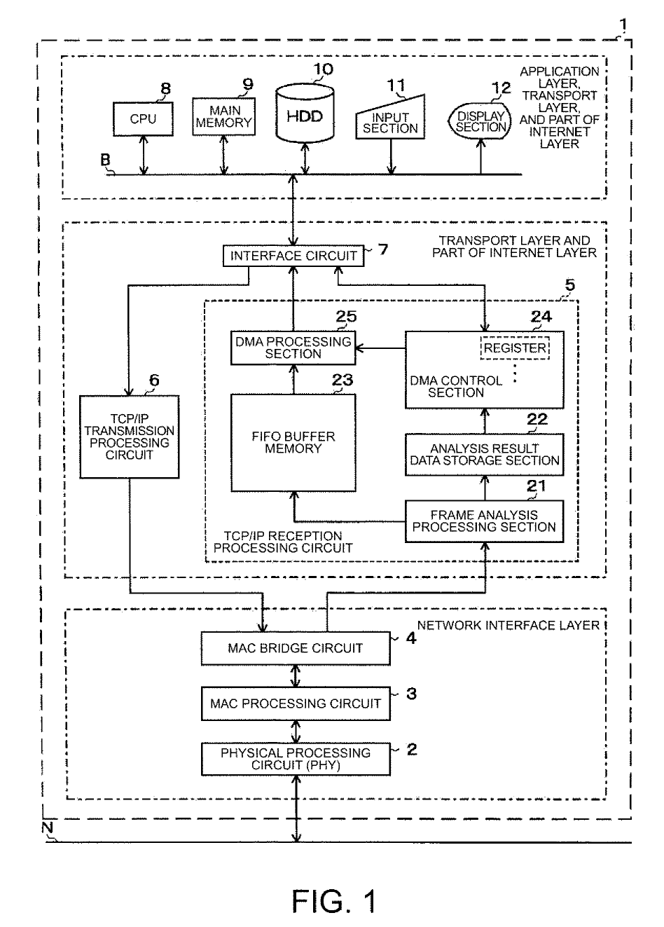

FIG. 1 is a block diagram showing an outline of a computer using the transmission control protocol/Internet protocol (TCP/IP) reception processing circuit of one embodiment of the invention. This computer 1 includes: a physical layer processing circuit (PHY) 2 coupled to network N, a media access control (MAC) processing circuit 3, a MAC bridge circuit 4, a TCP/IP reception processing circuit 5 as one embodiment of the invention, a TCP/IP transmission processing circuit 6, an interface circuit 7, a CPU 8, a main memory 9, a hard disk drive (HDD) 10, an input section 11, and a display section 12.

In the present embodiment, the network interface layer of the TCP/IP hierarchical model is Ethernet (trademark), and the physical layer processing circuit 2, the MAC processing circuit 3, and the MAC bridge circuit 4 carry out the network interface layer. The physical player processing circuit 2 is coupled to the network N; the MAC processing circuit 3 is coupled to the physical player processing circuit 2; and the MAC bridge circuit 4 is coupled to the MAC processing circuit 3.

The TCP/IP reception processing circuit 5, the TCP/IP transmission processing circuit 6, and the interface circuit 7 carry out the Internet layer and part of the transport layer. The TCP/IP reception processing circuit 5 and the TCP/IP transmission processing circuit 6 are both interposed between and coupled to the MAC bridge circuit 4 and the interface circuit 7.

Further, the CPU 8, the main memory 9, the HDD 10, the input section 11, and the display section 12 carry out the Internet layer, part of the transport layer, and the application layer of the TCP/IP hierarchical model. For example, in the HDD 10, the operating system (OS), the application programming interface (API) program, a mail client program, a web browser program and the like are recorded, and the CPU 8 executes these programs using the main memory 9 as the work area. The CPU 8, the main memory 9, the HDD 10, the input section 11, and the display section 12 are coupled to each other via a bus B, and the bus B is coupled to the interface circuit 7.

The TCP/IP reception processing circuit 5 includes a frame analysis processing section 21, an analysis result data storage section 22, a first-in-first-out (FIFO) buffer memory 23, a direct memory access (DMA) control section 24, and a DMA processing section 25. The DMA control section 24 contains a plurality of registers mapped to an I/O address space of the CPU 8.

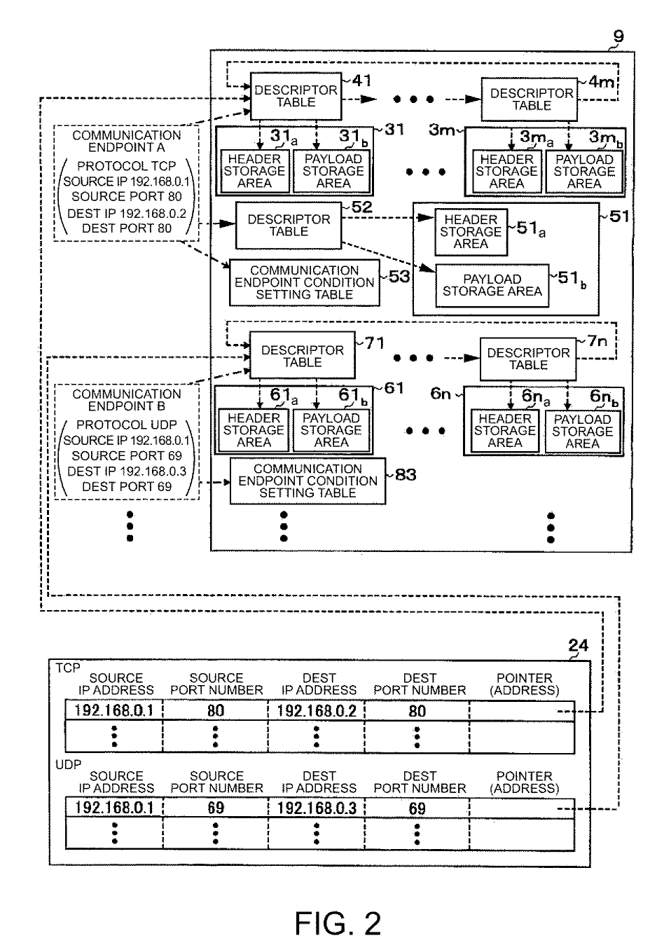

FIG. 2 is a diagram showing one example of the contents of the plurality of registers in the DMA control section 24 and of the main memory 9.

When the API that establishes a communication endpoint in the application layer is called, one group of areas corresponding to an established communication endpoint is produced in the main memory 9 by the API. FIG. 2 shows a first group of areas corresponding to a communication endpoint A (in this case, protocol is the transmission control protocol: TCP; source IP address is 192.168.0.1; source port number is 80; destination IP address is 192.168.0.2; and destination port number is 80) and a second group of areas corresponding to a communication endpoint B (in this case, protocol is the user datagram protocol: UDP; source IP address is 192.168.0.1; source port number is 69; destination IP address is 192.168.0.3; and destination port number is 69).

The first group of areas includes a plurality of packet storage areas 31-3m to store each of the packets addressed to the communication endpoint A. The packet storage areas 31-3m each include their respective header storage areas 31ₐ-3mₐ and payload storage areas 31_{b}-3m_{b}. Also, the first group of areas further includes descriptor tables 41-4m having pointers to their respective header storage areas 31ₐ-3mₐ and payload storage areas 31_{b}-3m_{b}.

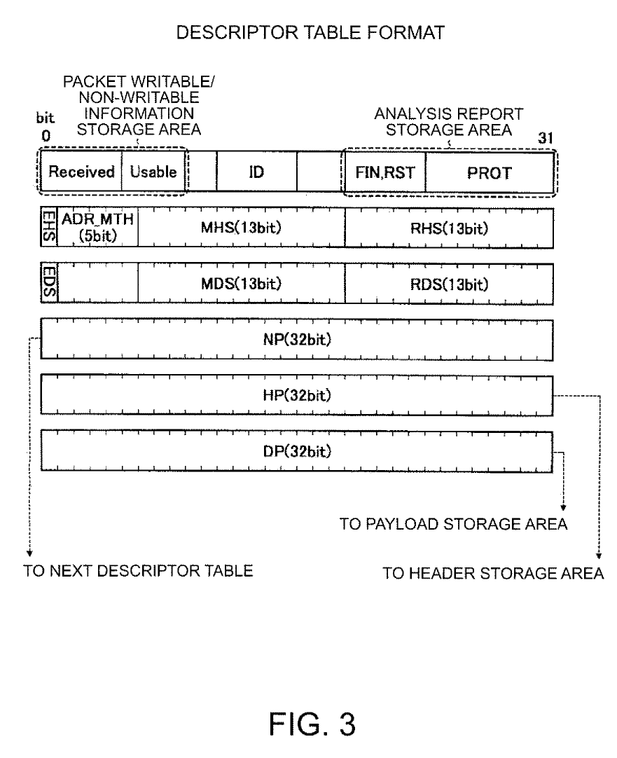

FIG. 3 is a diagram showing a format of the descriptor tables 41-4m. As shown in FIG. 3, the descriptor tables 41-4m are each composed of six words (in the embodiment, one word is 32-bit width). The first word contains a packet writable/non-writable information storage area to store information on whether or not the packet can be written into the packet storage area that is pointed out by this descriptor table. The packet writable/non-writable information storage area contains a Received field to store information on whether or not the packet is stored in the packet storage area that is pointed out by this descriptor table and a Usable field to store information on whether or not the packet storage area pointed out by this descriptor table is usable.

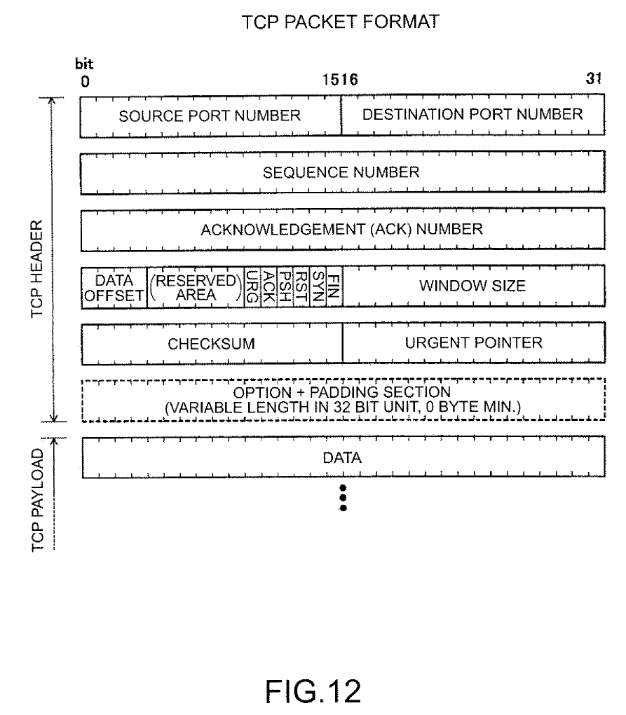

The first word of the descriptor tables 41-4m further contains an analysis report storage area to store a report on the analysis result of the packet stored in the packet storage area that is pointed out by this descriptor table. The analysis report storage area contains FIN and RST fields that store information indicating whether or not a FIN flag or an RST flag (see FIG. 12) in the TCP header is set and a PROT field that stores information indicating the kind of protocol (in this case, TCP).

The second word of the descriptor tables 41-4m further contains an MHS field (13-bit width) that stores information indicating the maximum size of a header storable in the header storage area that is pointed out by this descriptor table. The value of this field is set at the establishing stage of the communication endpoint. Also, the second word of the descriptor tables 41-4m further contains an RHS field (13-bit width) that stores information indicating an actual size of the header stored in the header storage area that is pointed out by this descriptor table. Further, the second word of the descriptor tables 41-4m further contains an EHS field that stores information indicating that an error has occurred, the error being that the value of the RHS field is larger than the value of the MHS field.

The third word of the descriptor tables 41-4m contains an MDS field (13-bit width) that stores information indicating the maximum size of a payload storable in the payload storage area that is pointed out by this descriptor table. Also, the third word of the descriptor tables 41-4m further contains an RDS field (13-bit width) that stores information indicating an actual size of the payload stored in the payload storage area pointed out by this descriptor table. Further, the third word of the descriptor tables 41-4m further contains an EDS field that stores information indicating that an error has occurred, the error being that the value of the RDS field is larger than the value of the MDS field.

The fourth word of the descriptor tables 41-4m contains an NP field (32-bit width) that stores a pointer (an address) pointing out the next descriptor table. By this NP field, the plurality of descriptor tables is linked to form a ring configuration (see FIG. 2). Accordingly, the packet storage areas 31-31m can be used similarly as the FIFO buffer.

The fifth word of the descriptor tables 41-4m contains an HP field (32-bit width) that stores a pointer (an address) pointing out the header storage area.

The sixth word of the descriptor tables 41-4m contains a DP field (32-bit width) that stores a pointer (an address) pointing out the payload storage area.

Additionally, the API that establishes the communication endpoint (more specifically, the CPU 8 that executes the API program) can vary the sizes of the header storage areas 31ₐ-3mₐ and the payload storage areas 31_{b}-3m_{b}. Even if the sizes of the header storage areas 31ₐ-3mₐ and the payload storage areas 31_{b}-3m_{b} are varied, the TCP/IP reception processing circuit 5 can detect their sizes since the sizes of the header storage areas 31ₐ-3mₐ and the payload storage areas 31_{b}-3m_{b} are set in the MHS field and the MDS field of the descriptor tables 41-4m, respectively.

Referring again to FIG. 2, the first group of areas further includes a packet storage area 51 that stores the RST packet (the packet in which the RST flag in the TCP header is set; see FIG. 12) to cut the connection of TCP. The packet storage area 51 includes a header storage area 51ₐ and a payload storage area 51_{b}. Further, the first group of areas further includes a descriptor table 52 that points out the header storage area 51ₐ and the payload storage area 51_{b}. The format of the descriptor table 52 is the same as that of the descriptor tables 41-4m shown in FIG. 3. The reason that the packet storage area 51 is provided separately from the packet storage areas 31-3m is as follows. With the TCP, receiving the RST packet means receiving an instruction to cut session. Therefore, even if the RST packet addressed to the communication endpoint A is received while other packets are stored in all the packet storage areas 31-3m, it is possible to reliably transfer and store the received RST packet into the main memory 9, to reliably cut the connection of the TCP in the application layer, and to eliminate concerns that the communication endpoint may not function until the session time-out and that this may negatively and largely affect the communication efficiency.

Additionally, the first group of areas further includes a communication endpoint condition-setting table 53 to store information on the communication endpoint A.

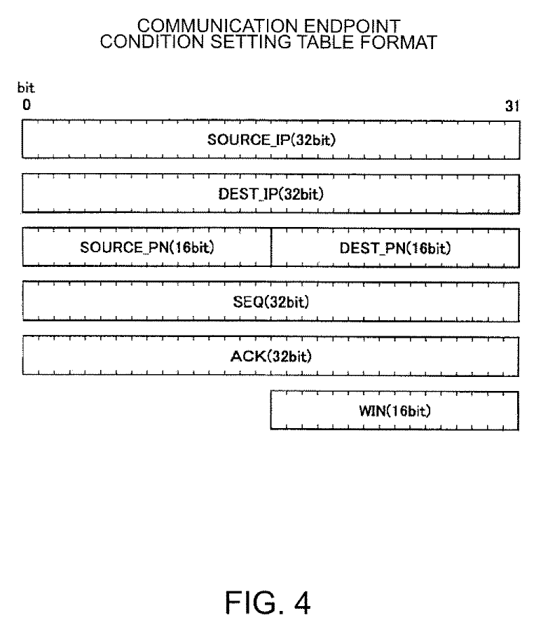

FIG. 4 is a diagram showing a format of the communication endpoint condition-setting table 53. As shown in FIG. 4 the communication endpoint condition-setting table 53 is composed of five words and half a word. The first word contains a SOURCE_IP field (32-bit width) to store the source (self) IP address of the communication endpoint A.

The second word of the communication endpoint condition-setting table 53 contains a DEST_IP field (32-bit width) to store the destination (opposite) IP address of the communication endpoint A.

The third word of the communication endpoint condition-setting table 53 contains a SOURCE_PN field (16-bit width) to store the source (self) port number of the communication endpoint A and a DEST_PN field (16-bit width) to store the destination (opposite) port number of the communication endpoint A.

The fourth word of the communication endpoint condition-setting table 53 contains an SEQ field (32-bit width) to store a sequence number of the communication endpoint A.

The fifth word of the communication endpoint condition-setting table 53 contains an ACK field (32-bit width) to store an acknowledgement number of the communication endpoint A.

The last half word of the communication endpoint condition-setting table 53 contains a WIN field (16-bit width) to store a window size of the communication endpoint A.

Referring again to FIG. 2, the second group of areas corresponding to the communication endpoint B includes a plurality of packet storage areas 61-6n to store each of the packets addressed to the communication endpoint B. The packet storage areas 61-6n each contain header storage areas 61ₐ-6n_{b} and payload storage areas 61_{b}-6n_{b}. Also, the second group of areas further includes descriptor tables 71-7n, each having pointers to the header storage areas 61ₐ-6nₐ and payload storage areas 61_{b}-6n_{b} and a communication endpoint condition-setting table 83 that stores information on the communication endpoint B.

The protocol of the communication endpoint B is UDP, and there is no such thing as an RST packet addressed to the communication endpoint B. Therefore, the second group of areas does not include such an area to store the RST packet as the packet storage area 51 or the descriptor table 52 in the first group of areas described hereinbefore.

Further, the protocol of the communication endpoint B is UDP, and there is no such thing as a FIN packet or an RST packet addressed to the communication endpoint B. Therefore, although the descriptor tables 71-7n are approximately the same as the descriptor tables 41-4m as shown in FIG. 3, the FIN and RST fields of the first word are not required.

Further, the protocol of the communication endpoint B is UDP, and there are no such things as a sequence number, acknowledgement number, or a window size in the communication endpoint B. Accordingly, the communication endpoint condition-setting table 83 in the second group of areas needs only three words, of the first word to the third word (the source IP address, destination IP address, source port number, and the destination port number), of the communication endpoint condition-setting table 53 shown in FIG. 4

In contrast, the registers in the DMA control section 24 are divided into a first group of registers for the communication endpoints of the TCP and a second group of registers for the communication endpoints of the UDP. Each of these registers of the first and second groups includes: a first field to store the source (self) IP address, a second field to store the source (self) port number, a third field to store the destination (opposite) IP address, a fourth field to store the destination (opposite) port number, and a fifth field to store the pointer (the address) that points out one out of the plurality of descriptor tables corresponding to the communication endpoint which is specified by the values of the first through fourth fields.

As described hereinbefore, each of the registers in the DMA control section 24 is mapped to the I/O address space of the CPU 8 and is accessible as the I/O from the CPU 8. Then, when the API that establishes the communication endpoint in the application layer is called, the descriptor tables, packet storage areas, and the like corresponding to the established communication endpoint are produced in the main memory 9 by the API, while the source (self) IP address, source (self) port number, destination (opposite) IP address, and the destination (opposite) port number that specify the established communication endpoint and the pointer (the address) that points out one out of the plurality of descriptor tables corresponding to the established communication endpoint are written into the register in the DMA control section 24 by the API.

Additionally, there is a case that the computer 1 may receive packets of a protocol of the transport layer other than the TCP or the UDP such as an Internet control message protocol (ICMP) or of a protocol of the network layer other than the IP Version 4 such as an address resolution protocol (ARP), a reverse address resolution protocol (RARP), or IP Version 6. To prepare for such a case, one group of areas (hereinafter referred to as a “junk buffer”) that stores the packets of the protocol other than the TCP or the UDP or of the protocol of the network layer other than the IP Version 4 is prepared in advance in the main memory 9. The junk buffer includes a plurality of packet storage areas to store the packets of a protocol of the transport layer other than the TCP or the UDP or of a protocol of the network layer other than the IP Version 4, and a plurality of descriptor tables each having pointers to these packet storage areas.

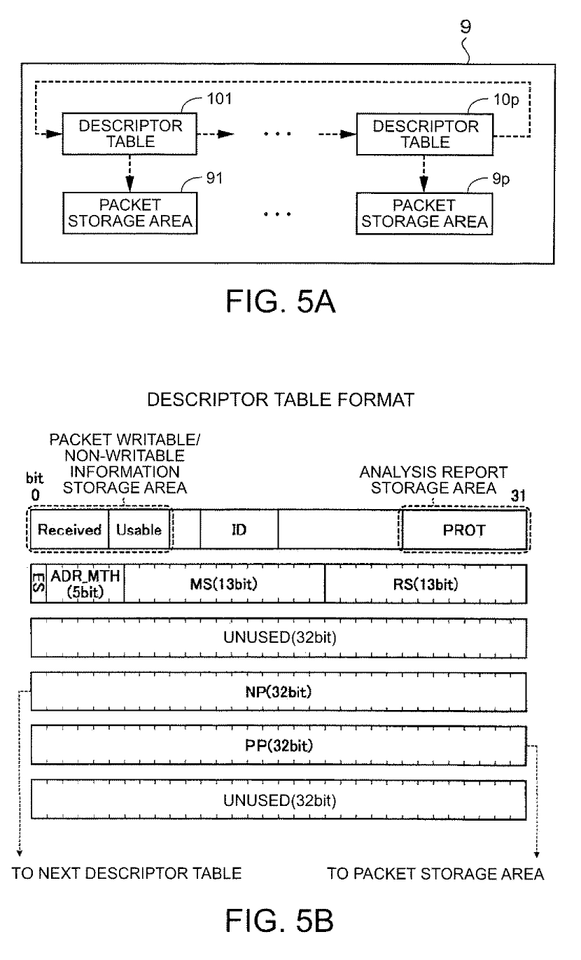

FIG. 5A is a diagram showing the junk buffer in the main memory 9. The junk buffer here includes a plurality of packet storage areas 91-9p and descriptor tables 101-10p.

FIG. 5B is a diagram showing a format of the descriptor tables 101-10p. As shown in FIG. 5B, the descriptor tables 101-10p are each composed of six words. The first word contains a packet writable/non-writable information storage area that stores information on whether or not the packet can be written into the packet storage area that is pointed out by this descriptor table. In this case, the packet writable/non-writable information storage area contains the Received field to store information on whether or not the packet is stored in the packet storage area that is pointed out by this descriptor table and the Usable field to store information on whether or not the packet storage area pointed out by this descriptor table is usable.

The first word of the descriptor tables 101-10p further contains the analysis report storage area to store a report on the analysis result of the packet stored in the packet storage area that is pointed out by this descriptor table. In this case, the analysis report storage area contains the PROT field to store information indicating the type of protocol.

The second word of the descriptor tables 101-10p further contains an MS field (13-bit width) that stores information indicating the maximum size of the packet storable in the header storage area that is pointed out by this descriptor table. The value of this field is set at the initial stage. Also, the second word of the descriptor tables 101-10p further contains an RS field (13-bit width) that stores information indicating the actual size of the packet stored in the packet storage area that is pointed out by this descriptor table. Moreover, the second word of the descriptor tables 101-10p further contains an ES field that stores information indicating that an error has occurred, the error being that the value of the RS field is larger than the value of the MS field.

The third word of the descriptor tables 101-10p is unused.

The fourth word of the descriptor tables 101-10p contains an NP field (32-bit width) that stores a pointer (an address) to point the next descriptor table. By this NP field, the plurality of descriptor tables is linked to form the ring configuration (see FIG. 5A). Accordingly, the packet storage areas 91-9m can be used similarly as the FIFO buffer.

The fifth word of the descriptor tables 101-10p contains a PP field (32-bit width) that stores a pointer (an address) to point the packet storage area.

The sixth word of the descriptor tables 101-10p is unused.

Now, the operation of the TCP/IP reception processing circuit 5 will be described.

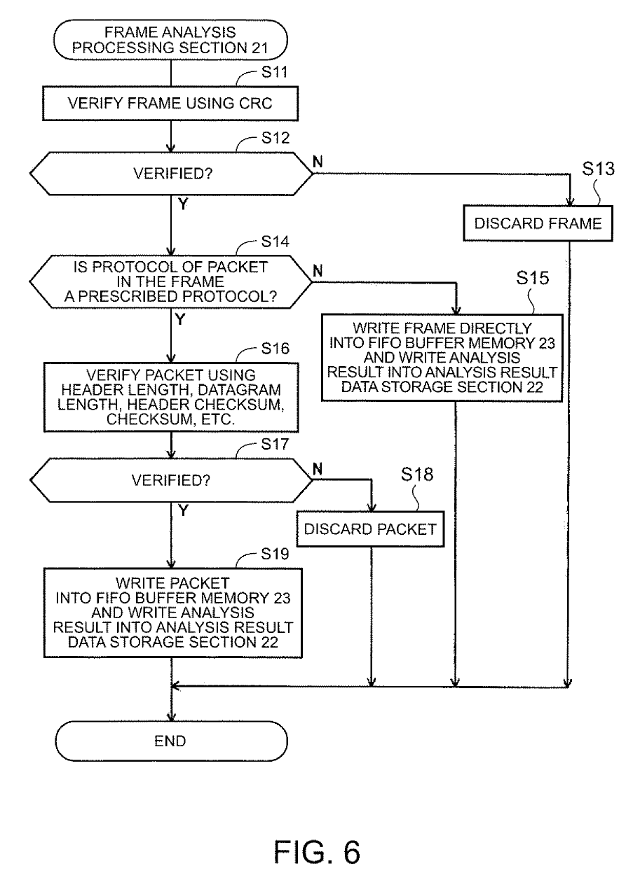

First, the operation of the frame analysis processing section 21 in the TCP/IP reception processing circuit 5 will be described. FIG. 6 is a flowchart showing the operation of the frame analysis processing section 21. Upon receipt of a frame from the MAC bridge circuit 4 of the network interface layer, the frame analysis processing section 21 starts the process as shown in FIG. 6.

First, the frame analysis processing section 21 verifies the frame (Step S1) by using the cyclic redundancy check (CRC) in the frame check sequence that is appended to the end of the frame received from the MAC bridge circuit 4. Then, if it is determined that there is an error, the frame analysis processing section 21 proceeds with the process to a step S13 and, if it is determined that there is no error, proceeds with the process to a step S14 (Step S12).

If it is determined that there is an error in the step S12, the frame analysis processing section 21 discards the frame (Step S13) and terminates the process.

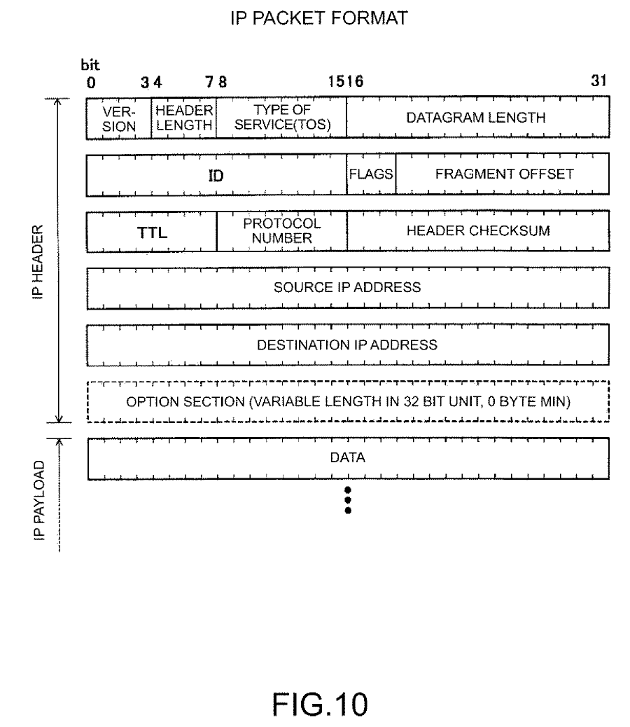

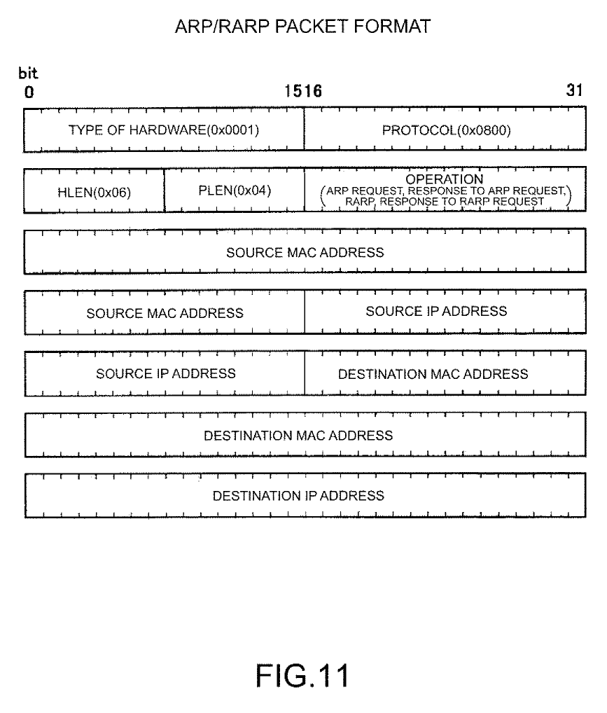

If it is determined that there is no error in the step S12, the frame analysis processing section 21 checks whether or not the protocols of the packet stored in the payload of the frame is the prescribed protocols (that is, in the embodiment, when the protocol of the Internet layer is IP and the protocol of the transport layer is TCP; the protocol of the Internet layer is IP and the protocol of the transport layer is UDP; the protocol of the Internet layer is IP and the protocol of the transport layer is ICMP; the protocol of the Internet layer is ARP; or the protocol of the Internet layer is RARP). Whether or not the protocols are the prescribed protocols can be determined by checking whether or not the packets match the formats as shown in FIGS. 10 through 14. Then, if the frame analysis processing section 21 determines that the protocols of the packet stored in the payload of the frame are not the prescribed protocols (for example, when the protocol of the network layer of the packet stored in the payload of the frame is IP Version 6, or when the protocol of the network layer of the packet stored in the payload of the frame is IP but the protocol of the transport layer is a protocol other than TCP, UDP, and ICMP), the process proceeds with the process to a step S15. If it is determined that the protocols of the packet stored in the payload of the frame are the prescribed protocols, the process proceeds with the process to a step S16 (Step S14).

If it is determined that the protocols of the packet stored in the payload of the frame are not the prescribed protocols in the step S14, the frame analysis processing section 21 writes the frame directly into the FIFO buffer memory 23 while writing the analysis results of the frame and the protocols into the analysis result data storage section 22 and terminates the process. Additionally, as will be described hereafter, the frame written in by the FIFO buffer memory 23 is transferred to the junk buffer in the main memory 9. Then, the frame that is transferred to the junk buffer undergoes the processes of the Internet layer and the transport layer by the CPU and the software (the program).

If it is determined that the protocols of the packet stored in the payload of the frame are the prescribed protocols in the step S14, the frame analysis processing section 21 verifies the packet using the information in the packet stored in the payload of the frame (Step S16).

For example, if the packet stored in the payload of the frame is the IP packet (see FIG. 10), the frame analysis processing section 21 verifies the IP packet stored in the payload of the frame by using the value of the “header length” field, the “datagram length” field, and the “header checksum” field in the IP header

Also, if the packet stored in the payload of the frame is the IP packet and the packet stored in the payload of the IP packet is the TCP packet (see FIG. 12), the frame analysis processing section 21 further verifies the TCP packet using the value of the “checksum” field in the TCP header.

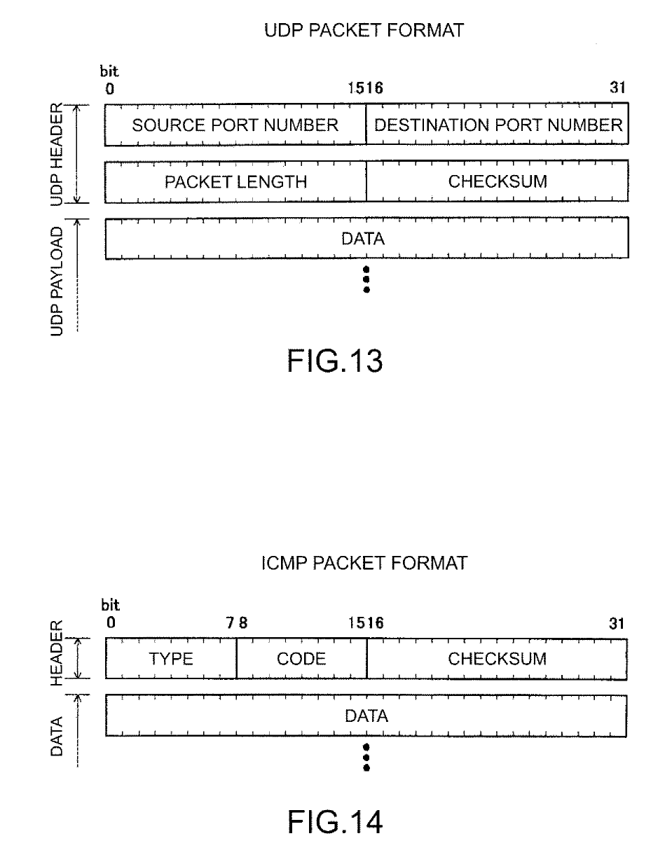

Further, if the packet stored in the payload of the frame is the IP packet and the packet stored in the payload of the IP packet is the UDP packet (see FIG. 13), the frame analysis processing section 21 further verifies the UDP packet using the values of the “packet length” field and the “checksum” field in the UDP header.

Furthermore, if the packet stored in the payload of the frame is the IP packet and the packet stored in the payload of the IP packet is the ICMP packet (see FIG. 14), the frame analysis processing section 21 further verifies the ICMP packet using the value of the “checksum” field in the ICMP header.

Referring again to FIG. 6, if it is determined that there is an error in the packet, the frame analysis processing section 21 proceeds with the process to a step S18 and, if it is determined that there is no error, proceeds with the process to a step S19 (Step S17).

If it is determined that there is an error in the step S17, the frame analysis processing section 21 discards the packet (Step S18) and terminates the process.

If it is determined that there is no error in the step S17, the frame analysis processing section 21 writes the packet into the FIFO buffer memory 23 while writing the analysis result of the packet into the analysis result data storage section 22 (Step S19) and terminates the process.

In this situation, if the protocol of the packet stored in the payload of the frame received from the MAC bridge circuit 4 is the ARP or the RARP, the frame analysis processing section 21 writes the ARP packet or the RARP packet into the FIFO buffer memory 23. Further if the protocol of the packet stored in the payload of the frame received from the MAC bridge circuit 4 is the IP, the frame analysis processing section 21 writes the packet (in the embodiment, the TCP packet, UDP packet, or the ICMP packet) stored in the payload of the IP packet into the FIFO buffer memory 23.

The analysis result which the frame analysis processing section 21 writes into the analysis result data storage section 22 includes the protocols (which is, in the embodiment, the protocol of the Internet layer is IP and the protocol of the transport layer is TCP; the protocol of the Internet layer is IP and the protocol of the transport layer is UDP; the protocol of the Internet layer is IP and the protocol of the transport layer is ICMP; the protocol of the Internet layer is ARP; or the protocol of the Internet layer is RARP) and the sizes of the packets. Further, if the protocols of the packet stored in the payload of the frame received from the MAC bridge circuit 4 are such that the protocol of the Internet layer is IP and the protocol of the transport layer is TCP or that the protocol of the Internet layer is IP and the protocol of the transport layer is UDP, then, the analysis result written into the analysis result data storage section 22 by the frame analysis processing section 21 further includes the size of the TCP header or the UDP header, the size of the TCP payload or the UDP payload, and the information to specify the communication endpoint (the source IP address, source port number, destination IP address, and the destination port number). In addition, the source (self) IP address and the destination (opposite) IP address are stored in the IP header (see FIG. 10), and the source (self) port number and the destination (opposite) port number are stored in the TCP header (see FIG. 12) or the UDP header (see FIG. 13).

Further, the frame analysis processing section 21 may be provided with a plurality of automatic addition counters mapped to the I/O address space of the CPU 8, and the initial value of the sequence number of the communication endpoint of the TCP at the establishing stage of the communication endpoint of the TCP may be written into any of the automatic addition counters by the API. Then, when the frame analysis processing section 21 receives from the MAC bridge circuit 4 the frame stored in the packet addressed to the communication endpoint of the TCP, and if the sequence number in this packet (FIG. 12) matches with the value of the automatic addition counter, the frame analysis processing section 21 may write this packet into the FIFO buffer memory 23 while incrementing the automatic addition counter. If the sequence number in this packet does not match with the value of the automatic addition counter, the frame analysis processing section 21 may discard this packet. With the TCP, the verification of the sequence numbers assures the arriving order of the packets and the safety of the basic communication paths. Generally, one logical data stream is often composed of a plurality of received packets. As described, by providing the automatic addition counters, it becomes possible to eliminate the necessity of determining whether or not to receive the packet by the software.

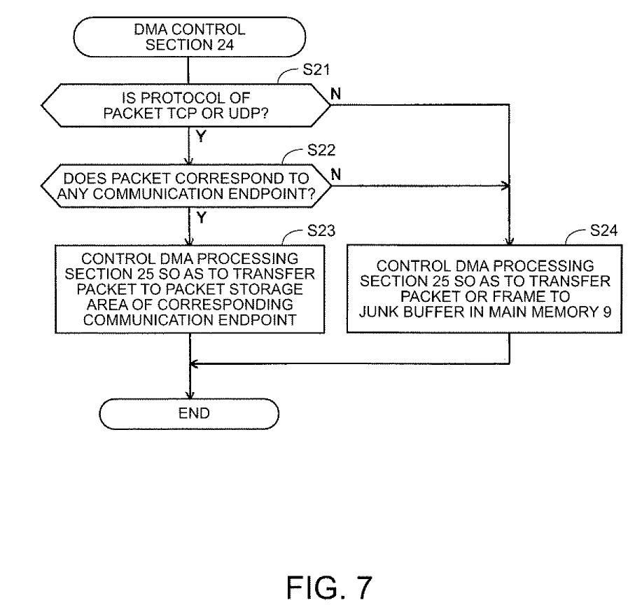

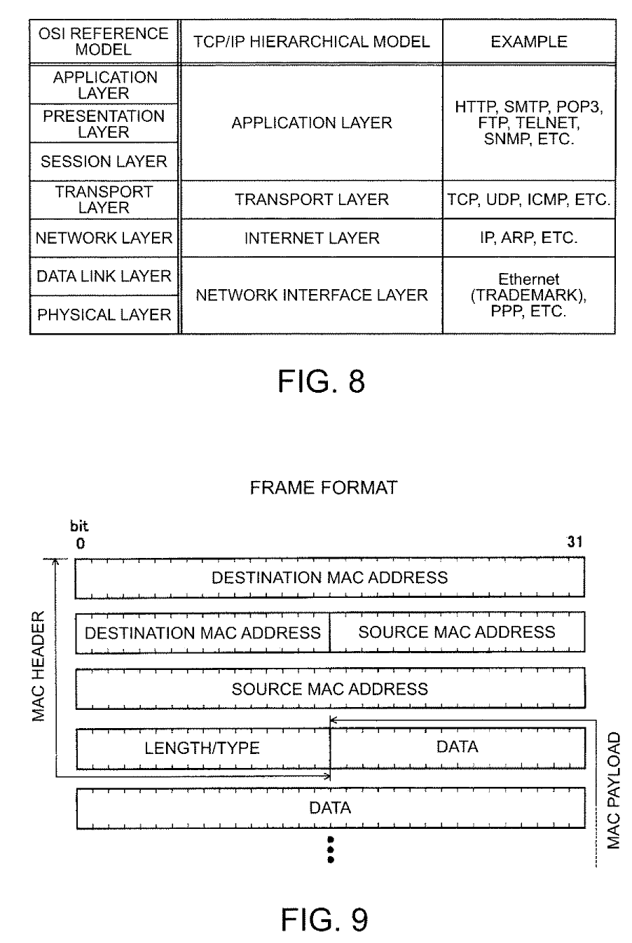

Next, the operation of the DMA control section 24 in the TCP/IP reception processing circuit 5 will be described. FIG. 7 is a flowchart showing the operation of the DMA control section 24.

The DMA control section 24: refers to the protocols in the analysis result stored in the analysis result data storage section 22, checks if the packet or the like (packet or frame) stored in the FIFO buffer memory 23 is the TCP packet or the UDP packet, proceeds with the process to a step S22 if the packet or the like stored in the FIFO buffer memory 23 is the TCP packet or the UDP packet, and, if it is determined that the packet or the like stored in the FIFO buffer memory 23 is not the TCP packet or the UDP packet, proceeds with the process to a step S24 (Step S21).

If the packet or the like stored in the FIFO buffer memory 23 is determined as the TOP packet or the UDP packet in the step S21, the DMA control section 24 further refers to the information (the source IP address, source port number, destination IP address, and the destination port number) to specify the communication endpoint in the analysis result stored in the analysis result data storage section 22 and checks whether or not the TCP packet or the UDP packet stored in the FIFO buffer memory 23 is addressed to any of the communication endpoints. More specifically, the registers in the DMA control section 24 store the information required to specify the established communication endpoint (See FIG. 2), and, by comparing the information required to specify the established communication endpoint in the analysis result stored in the analysis result data storage section 22 with the contents of the registers, the DMA control section 24 can check whether or not the TCP packet or the UDP packet stored in the FIFO buffer memory 23 is addressed to any of the communication endpoints. Alternatively, the DMA control section 24 can check whether or not the TCP packet or the UDP packet stored in the FIFO buffer memory 23 is addressed to any of the communication endpoints by comparing the information required to specify the communication endpoint in the analysis result stored in the analysis result data storage section 22 with the contents of the communication endpoint condition-setting table 53 in the main memory 9. Then, if it is determined that the TCP packet or the UDP packet stored in the FIFO buffer memory 23 is addressed to any of the communication endpoints, the DMA control section 24 proceeds with the process to a step S23 and, if it is determined that the TCP packet or the UDP packet stored in the FIFO buffer memory 23 is not addressed to any of the communication endpoints, proceeds with the process to the step S24 (Step S22).

If it is determined, in the step S22, that the TCP packet or the UDP packet stored in the FIFO buffer memory 23 is addressed to any of the communication endpoints, the DMA control section 24 controls the DMA processing section 25 so as to DMA-transfer the TCP packet or the UDP packet stored in the FIFO buffer memory 23 to the packet storage area of the communication endpoint that is the destination of the TCP packet or the UDP packet stored in the FIFO buffer memory 23 (Step S23).

More specifically, if the packet stored in the FIFO buffer memory 23 is the TCP packet addressed to the communication endpoint A, the DMA control section 24 controls the DMA processing section 25 so as to transfer the TCP packet stored in the FIFO buffer memory 23 to any of the packet storage areas 31-3m (see FIG. 2). Which packet storage area between 31 and 3m is to become the DMA transfer destination can be determined by successively referring, from the pointers (the addresses) in the register, to the packet writable/non-writable information storage areas (see FIG. 3) in the descriptor tables 41-4m and by searching the packet storage area into which the packet can be written. Also, the amount of the DMA transfer (the size of the DMA transfer data) can be determined by referring to the sizes of the TCP header and the TCP payload that are stored in the analysis result data storage section 22. If the size of the header or the payload of the TCP packet stored in the FIFO buffer memory 23 exceeds the size (detectable by the MHS field or the MDS field in FIG. 3) of the header storage area or the payload storage area which is the transfer destination, the DMA control section 24 may DMA-transfer only part of the header or payload of this packet storable in the header storage area or the payload storage area and may not DMA-transfer the part exceeding the size of the header storage area or the payload storage area, which is the transfer destination, in the header or the payload of this packet.

Similarly, if the packet stored in the FIFO buffer memory 23 is the UDP packet addressed to the communication endpoint B, the DMA control section 24 controls the DMA processing section 25 so as to transfer the UDP packet stored in the FIFO buffer memory 23 to any of the packet storage areas 61-6n (see FIG. 2). Further, which packet storage area between 61 and 6n is to become the DMA transfer destination can be determined by successively referring, from the pointers (the addresses) in the register, to the packet writable/non-writable information storage area (see FIG. 3) in the descriptor tables 71-7n and by searching the packet storage area into which the packet can be written. Also, the amount of the DMA transfer (the size of the DMA transfer data) can be determined by referring to the sizes of the UDP header and UDP payload stored in the analysis result data storage section 22. If the size of the header or the payload of the UDP packet stored in the FIFO buffer memory 23 exceeds the size (detectable by the MHS field or the MDS field in FIG. 3) of the header storage area or the payload storage area which is the transfer destination, the DMA control section 24 may DMA-transfer only part of the header or the payload of this packet storable in the header storage area or the payload storage area which is the transfer destination, and may not DMA-transfer the part exceeding the size of the header storage area or the payload storage area in the header or the payload of this packet.

In contrast, if it is determined that the packets stored in the FIFO buffer memory 23 are not the TCP packets or the UDP packets in the step S21, or if it is determined that the packets stored in the FIFO buffer memory 23 are also not the TCP packet or the UDP packet addressed to any communication endpoints, the DMA control section 24 controls the DMA processing section 25 so as to DMA-transfer the packets stored in the FIFO buffer memory 23 to the junk buffer (Step S24). When the DMA transfer is finished, the DMA control section 24 outputs a packet reception announcement control signal to the CPU 8, and the CPU 8 reads out the packets, and, thereby, it becomes possible to process the Internet layer and the transport layer by the software (the program).

Additionally, the DMA control section 24 may be provided with a plurality of decrement counters mapped to the I/O address space of the CPU 8, and the initial size of a logical data stream block (this may be a window buffer size) of the communication endpoint may be written into any of the decrement counters by the API at the establishing stage of the communication endpoint. Then, every time the DMA control section 24 DMA-transfers, in the step S23, the payload part of the TCP packet or the UDP packet stored in the FIFO buffer memory 23 to the payload storage area of the communication endpoint that is the destination of the TCP packet or the UDP packet stored in the FIFO buffer memory 23, the value of the decrement counter corresponding to the communication endpoint may be subtracted by the amount DMA-transferred. Then, if the DMA control section 24 is not to output the packet reception announcement control signal to the CPU 8 until the decrement counter becomes 0 but to output the same to the CPU 8 when the decrement counter has become 0, the application layer can handle the logic data stream of a fixed length composed of the plurality of received packets all at once, and software overhead (e.g., the number of occurrences of task switching and interruption) can be reduced. Further, the DMA control section 24 may not DMA-transfer the part exceeding the value of the decrement counter in the payload.

As described hereinabove, according to the embodiment, the transfer of the packet addressed to the communication endpoint of the TCP or the UDP into the packet storage area in the main memory 9 by the TCP/IP reception processing circuit 5 can be simplified by having the descriptor tables linked, and the application layer can readily handle the logic data stream block that is defined by the number of the received packets.

Further, according to the embodiment, the header or the payload of the packet addressed to the communication endpoint of the TCP or the UDP can be transferred to the header storage area and the payload storage area provided in the main memory 9. Consequently, when there is a plurality of packets addressed to one communication endpoint, the application layer can freely use the payload without referring to the header. In this situation, if the plurality of payload storage areas is arranged at successive addresses, it becomes possible that the application layer can successively access the plurality of payloads.

Furthermore, in the embodiment, if the size of the header or the payload addressed to the communication endpoint of the TCP or the UDP exceeds the size of the header storage area or the payload storage area which is the transfer destination, the part that exceeds the size of the header storage area or the payload storage area in the header or the payload of this packet is not DMA-transferred. Therefore, if a third party is to send an unauthorized packet to the computer 1 and the unauthorized packet happens to match the setting condition of the communication endpoint of the TCP or the UDP, the part that exceeds the size of the header storage area or the payload storage area which is the transfer destination in the header or the payload of the unauthorized packet is not DMA-transferred. Thus, the working area of the OS, API, or the application program is not to be overwritten by the unauthorized packet. Consequently, cracking and the like by the third party can be prevented.

In the embodiment, although Ethernet (trademark) is used as the network interface layer, other network may be used. Also, as the application layer various protocols such as a hypertext transfer protocol (HTTP) and the like may be used.

One aspect of the invention can be used in a TCP/IP reception processing circuit. This TCP/IP reception processing circuit can be used in personal computers, mobile telephones, PDAs, electric home appliances (e.g., televisions and refrigerators), and the like.

The entire disclosure of Japanese Patent Application No. 2005-147618, filed May 20, 2005 is expressly incorporated by reference herin.

What is claimed is:

1. A transmission control protocol/Internet protocol (TCP/IP) reception processing circuit that transmits a packet included in a frame and received from a lower layer to memory accessible by an upper layer, wherein:
the memory includes: a communication endpoint information area which contains a plurality of packet storage areas, with each packet storage area storing a plurality of packets addressed to a predetermined communication endpoint, and which contains a plurality of descriptor tables linked to a first pointer included in each packet storage area, with each descriptor table having a second pointer that points out the packet storage area and having packet writable/non-writable information that indicates whether or not the packet can be written into the packet storage area pointed out by the second pointer; and
if a packet included in a frame and received from the lower layer is a packet addressed to the predetermined communication endpoint, one out of the plurality of descriptor tables that points out the packet storage area into which the packet can be written is determined by using the first pointer and the packet writable/non-writable information, and the packet included in the frame and received from the lower layer is transferred into the packet storage area pointed out by the second pointer in this descriptor table.

2. The TCP/IP reception processing circuit according to claim 1, wherein:
each of the plurality of packet storage areas includes a header storage area that stores a header of a packet and a payload storage area that stores a payload of a packet;
the second pointer includes a third pointer that points out the header storage area and a fourth pointer that points out the payload storage area; and
if a packet included in a frame and received from the lower layer is a packet addressed to the predetermined communication endpoint, one out of the plurality of descriptor tables that points out a packet storage area into which the packet can be written is determined by using the first pointer and the packet writable/non-writable information; a header of the packet included in the frame and received from the lower layer is transferred into the header storage area that is pointed out by the third pointer in this descriptor table; and a payload of the packet included in the frame and received from the lower layer is transferred into the packet storage area that is pointed out by the fourth pointer in this descriptor table.

3. The TCP/IP reception processing circuit according to claim 2, wherein the payload storage areas in the plurality of packet storage areas are arranged at successive addresses in the memory.

4. The TCP/IP reception processing circuit according to claim 2, wherein:
each of the plurality of descriptor tables further includes header storage area size information indicating a size of a header storable in the header storage area and payload storage area size information indicating a size of a payload storable in the payload storage area; and
if a packet included in a frame and received from the lower layer is a packet addressed to the predetermined communication endpoint, one out of the plurality of descriptor tables that points out the packet storage area into which the packet can be written is determined by using the first pointer and the packet writable/non-writable information; and, when a size of a header of a packet included in a frame and received from the lower layer is larger than a size indicated by the header storage area size information in this descriptor table, part of the header of the packet included in the frame and received from the lower layer that is storable in the header storage area in this descriptor table is transferred to the header storage area of this descriptor table; and, when a size of a payload of a packet included in a frame and received from the lower layer is larger than a size indicated by the payload storage area size information in this descriptor table, part of the payload of the packet included in the frame and received from the lower layer that is storable in the payload storage area in this descriptor table is transferred to the payload storage area of this descriptor table.

5. The TCP/TP reception processing circuit according to claim 2, comprising:
a decrement counter with which an initial size of a logical data stream block of the predetermined communication endpoint can be set by the upper layer, in that: if a packet included in a frame and received from the lower layer is a packet addressed to the predetermined communication endpoint, the decrement counter subtracts a value equivalent to a size of a payload of the packet included in the frame and received from the lower layer; and, when the value of the decrement counter becomes 0, a control signal to the upper layer is output announcing that the value has become 0.

6. The TCP/IP reception processing circuit according to claim 1, wherein:
if the predetermined communication endpoint is a communication endpoint of a transmission control protocol (TCP),
the memory further includes an RST packet storage area that stores an RST packet addressed to the predetermined communication endpoint and an RST descriptor table having a pointer that points out the RST packet storage area; and
if a packet included in a frame and received from the lower layer is an RST packet addressed to the predetermined communication endpoint, the RST packet is transferred into the RST packet storage area pointed out by the pointer in the RST descriptor table.

7. The TCP/IP reception processing circuit according to claim 1, further comprising an addition counter with which an initial value of a sequence number of the predetermined communication endpoint can be set by the upper layer, in that: if a packet included in a frame and received from the lower layer is a packet addressed to the predetermined communication endpoint, and if a sequence number in a TCP header of this packet is equivalent to a value of the addition counter, the packet included in the frame and received from the lower layer is transferred to the memory while the value of the addition counter is incremented.

8. The TCP/IP reception processing circuit according to claim 1, wherein:
each of the plurality of descriptor tables further includes an analysis result storage area that stores an analysis result of a frame received from the lower layer or an analysis result of a packet included in a frame and received from the lower layer; and
if a packet included in a frame and received from the lower layer is a packet addressed to the predetermined communication endpoint, one out of the plurality of descriptor tables that points out the packet storage area into which the packet can be written is determined by using the first pointer and the packet writable/non-writable information, and the packet included in the frame and received from the lower layer is transferred into the packet storage area pointed out by the second pointer in this descriptor table, while an analysis result of the frame received from the lower layer or an analysis result of the packet included in the frame and received from the lower layer is written into the analysis result storage area in this descriptor table.

9. The TCP/IP reception processing circuit according to claim 1, wherein:
the memory includes the plurality of communication endpoint information areas each corresponding to a plurality of communication endpoints; and
if a packet included in a frame and received from the lower layer is a packet addressed to any of the plurality of communication endpoints, this packet is written into a packet storage area indicated in a descriptor table in a communication endpoint information area, out of the plurality of communication endpoint information areas, that corresponds to the communication endpoint that is the destination of this packet.

10. The TCP/IP reception processing circuit according to claim 9, wherein:
if a protocol of a packet included in a frame and received from the lower layer is not a prescribed protocol or if a packet included in a frame and received from the lower layer is a packet not addressed to any of the plurality of communication endpoints, the memory further includes a second communication endpoint information area that stores this frame or this packet; and
if the protocol of a packet included in a frame and received from the lower layer is not a prescribed protocol or if a packet included in a frame and received from the lower layer is a packet not addressed to any of the plurality of communication endpoints, and if a protocol of a packet included in a frame and received from the lower layer is not a prescribed protocol or if a packet included in a frame and received from the lower layer is a packet not addressed to any of the plurality of communication endpoints, this frame or this packet is transferred to a packet storage area indicated in a descriptor table in the second communication endpoint information area.

11. A semiconductor integrated circuit having the TCP/IP reception processing circuit of claim 1.
